(19) United States
(12) Patent Application Publication
(10) Pub. No.: US 2003/0111415 A1
(43) Pub. Date: Jun. 19, 2003

(54) Solution filtration method for polycarbonate purification

(75) Inventors: Dimitrios T. Hatziavramidis, Evansville, IN (US); Tylan Nelson, Evansville, IN (US)

Correspondence Address: Frank A. Smith, GE Plastics, One Plastics Avenue, Pittsfield, MA, 01201, US

(73) Assignee: General Electric Company

(21) Appl. No.: 10/014,014

(22) Filed: Dec. 10, 2001

(51) Int. Cl. B01D 61/00; B01D 37/00

(52) U.S. Cl. 210/650; 210/651

(57) ABSTRACT

The specification provides a description of a superior method of making polycarbonate containing fewer particulates by using a specific filter system for filtering organic solvent solution of polycarbonate resulting from phase separator of aqueous-organic mixture from reactor.

### FIELD OF THE INVENTION

The present specification relates to a method for producing polycarbonate having fewer particulate impurities. Specifically, the specification relates to the use of a particular filtration system for reducing particulate impurities by passing a methylene chloride solution of polycarbonate through said filtration system.

### BACKGROUND OF THE INVENTION

Polycarbonates are a well known industrially useful type of plastic that can be made transparent. These plastics are extremely tough and can be used for such applications as bullet-resistant windows. Substrates in compact disks (CD's) and digital video discs (DVD's) are also typically made primarily of polycarbonate.

As optical media storage device technologies (e.g., CD and DVD optical disks and new formats) are pushed to accommodate greater data storage densities, the polycarbonate used in such devices faces ever more stringent purity requirements. Specifically, as data density in optical disks is increased, requirements for purity become critical. Particulate impurities can interfere with reading particular bits of data because reading is generally accomplished by shining a laser beam through the polycarbonate and measuring its reflection. Obviously, this process will not work well if there are particulate impurities blocking the laser beam.

Commercially manufactured polycarbonates made by the well known interfacial manufacturing method generally have relatively high levels of particulate impurities that can be attributed to several sources. Specifically, monomers, solvents, catalysts, endcapping agents and additives used to make polycarbonate may themselves contain particulates; unreacted monomers, solvents, catalysts, endcapping agents and additives may form particulates; impurities generated by the process itself, such as byproducts, may form particulates; and abraded particulates of piping and equipment used in the manufacturing process may also contribute particulates.

For the foregoing reasons there is a need for development of improved methods for manufacturing polycarbonate with reduced levels of particulate impurities.

### BRIEF SUMMARY OF DRAWINGS

FIG. 1 shows a diagram of polycarbonate manufacturing by the interfacial process according to the invention.

FIG. 2 shows a diagrammatic view of a first filter according to the invention.

FIG. 3a shows a diagrammatic view of a second filter according to the invention, which filter comprises candle-type filter cartridges.

FIG. 3b shows a diagrammatic view of the candle-type filter cartridges depicted in FIG. 3a.

FIG. 4 shows a graph of particulates per gram of polycarbonate versus time for a filtration system not according to the invention.

FIG. 5 shows a graph of pressure drop versus time for a filtration system not according to the invention.

FIG. 6 shows a graph of particulates per gram of polycarbonate versus time for a filtration system according to one example of the invention.

FIG. 7 shows a graph of pressure drop versus time for a filtration system according to one example of the invention.

### BRIEF DESCRIPTION OF THE INVENTION

The specification describes a filtration system for filtering a solution of polycarbonate in methylene chloride. This filtration system has first filter and a second filter downstream from the first filter. The second filter has polytetrafluoroethylene membrane elements. These membrane elements are supported preferably on a polypropylene support. Both the first and second filters are made from materials that are compatible with (i.e., do not dissolve, are not deformed or swelled by) methylene chloride.

### DETAILED DESCRIPTION OF PREFFERED EMBODIMENTS

This detailed description is meant to provide some illustrative examples of the invention including its most preferred example as currently known by the author, but the invention itself is delineated by the claims appended hereto, which should not be read as limited by the illustrative examples described herein.

In the following specification, reference will be made to a number of terms, which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “polycarbonate” refers to a polycarbonate homopolymer or copolymer or polyestercarbonate made by the interfacial reaction of a dihydric phenol and a carbonate precursor. In this well-known method wherein the polymerization reaction typically occurs at a water/methylene chloride interface. The term “polycarbonate” is also meant to refer to copolymers of polycarbonate and blends with other thermoplastics.

“BPA” is herein defined as bisphenol A or 2,2-bis(4-hydroxyphenyl)propane.

The terms “diphenol” and “dihydric phenol” as used herein are synonymous.

All U.S. Patents referenced in this specification are incorporated by reference herein.

Techniques for the interfacial polymerization method of manufacturing polycarbonate are well known and are described, for example, by U.S. Pat. Nos. 3,945,969, 3,989,672 and 4,115,358, which are incorporated herein by reference.

In general, preferred processes for making polycarbonate via the interfacial method begin with the step of conducting a reaction between a dihydric phenol and a carbonate precursor in the presence of water, an organic solvent, a neutralization agent, a catalyst, and an endcapping agent. In typical cases, the neutralization agent is sodium hydroxide and the organic solvent is methylene chloride, but this is not necessarily the case as described below. This reaction results in a mixture containing an aqueous phase, which typically comprises a salt produced by reaction with the neutralization agent (typically NaCl), and an organic phase, which comprises the polycarbonate.

Next, the aqueous phase is separated from the organic phase and catalyst is removed from the organic phase. The aqueous phase may be cleaned and recycled. The organic phase may also be rinsed to remove any residual salt and/or catalyst or other agents.

Next, the organic phase may be filtered to remove impurities before polycarbonate is isolated from the organic phase. Filter systems for this filtration step are described in greater detail below.

Finally, polycarbonate powder is isolated from the organic solution, typically by steam precipitation followed by various other drying operations. Later, the polycarbonate powder produced by such operations will typically be compounded together with various additives by extrusion and pelletized.

Examples of suitable dihydric phenol monomers are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, [alpha], [alpha]′-bis-(4ydroxyphenyl)-p-diisopropylbenzere, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2;2-bis-(3,5-dimethyl-4-hydroxyphenyl)-propane, bis-(3,5-dimethyl-4-hydroxyphenyl)-sulfide, bis-(3,5-dimethyl-4-hydroxyphenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, [alpha], [alpha]′-bis-(3,5-dimethyl-4-hydroxyphenyl)-p-diisopropylbenzene 4,4′-sulfonyl diphenol, 2,2-bis-(4-hydroxyphenyl)-propane, 2,2-bis-(3,5-dimethyl-4-hydroxyphenyl)-propane, 1,1-bis-(4-hydroxyphenyl)-cyclohexane, 1,1-bis-(4-hydroxyphenyl)-3,3,5-trimethylcyclohexane.

Polycarbonates, which may be isolated by the method of this invention typically comprise structural units of the formula (I):

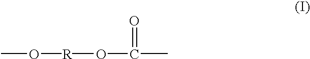

wherein at least about 60% of the total number of R groups are aromatic organic radicals and the balance thereof are aliphatic, alicyclic or aromatic radicals. Preferably, each R is an aromatic organic radical and more preferably a radical of the formula (II):

-A₁-Y-A₂ (II)

wherein each A₁ and A₂ is a monocyclic divalent aryl radical and Y is a bridging radical in which one or two carbonate atoms separate A₁ and A₂. Such radicals may be derived from dihydroxyaromatic compounds of the formulas OH—R—OH and OH— A₁ and A₂-OH, or their corresponding derivatives. A₁ and A₂ include but are not limited to unsubstituted phenylene, preferably p-phenylene or substituted derivatives thereof. The bridging radical Y is most often a hydrocarbon group and preferably a saturated group, such as methylene, cyclohexylidene or isopropylidene. Isopropylidene is the more preferred. Thus, the more preferred polycarbonates are those comprising residues of 2,2-bis(4-hydroxyphenyl)propane, also known as “bisphenol A”. In one embodiment, the polycarbonate is a homopolymer of bisphenol A.

(Co)polyestercarbonates may also be isolated by the method of this invention. The polyestercarbonate may comprise residues of aliphatic or aromatic diacids. The corresponding derivatives of aliphatic or aromatic diacids, such as the corresponding dichlorides, may also be utilized in the polymerization.

Suitable organic solvents for use in the interfacial process for polycarbonate synthesis include any organic solvent, which is substantially insoluble in water and inert to the process conditions. The organic solvent should also be a liquid under the reaction conditions and should not react with the carbonyl halide, or the caustic. Suitable organic solvents include, but are not limited to, aliphatic hydrocarbons such as pentane, hexane, cyclohexane, and heptane; aromatic hydrocarbons such as toluene, xylene; substituted aromatic hydrocarbons, such as chlorobenzene, dichlorobenzene, and nitrobenezene; chlorinated aliphatic hydrocarbons such as chloroform and methylene chloride, and mixtures of any of the aforementioned solvents. The aforementioned solvents may also be mixed with ethers, including but not limited to tetrahydrofuran. Chlorinated aliphatic hydrocarbons are preferred, in particular methylene chloride.

Suitable dihydric phenols utilized in the preparation of polycarbonate, include, but are not limited to, 2,2-bis-(4-hydroxyphenyl)-propane “BPA”; 2,2-bis(3,5-dibromo-4-hydroxyphenyl)propane; 2,2-bis(3,5-dimethyl-4-hydroxyphenyl)propane; 1,1-bis(4-hydroxyphenyl)cyclohexane; 1,1-bis(3,5-dimethyl-4-hydroxyphenyl)cyclohexane; 1,1-bis(4-hydroxyphenyl)decane; 1,1-bis(4-hydroxyphenyl)propane; 1,1-bis(4-hydroxyphenyl)cyclodecane; 1,1-bis(3,5-dimethyl-4-hydroxyphenyl)cyclododecane; 4,4-dihydroxyphenyl ether; 4,4-thiodiphenol; 4,4-dihydroxy-3,3-dichlorodiphenyl ether; 4,4-thiodiphenol; 4,4-dihydroxy-3,3-dichlorodiphenyl ether; 4,4-dihydroxy-2,5-dihydroxydiphenyl ether; BPI; 1,1-bis(4-hydroxyphenyl)-1-phenylethane; 1,1-bis (3-methyl-4-hydroxyphenyl)-1-phenylethane, hydroquinone, resorcinol, bis(hydroxyphenyl)-sulfoxides, bis-(hydrophenyl)-sulfides, bis-(hydroxyphenyl)-sulphones, and mixtures thereof. In one embodiment, the residues of dihydric phenol in the polycarbonate comprise 100 mol % of residues derived from BPA.

Optionally, polyfunctional compounds may be utilized as branching agents in the preparation of polycarbonate by an interfacial process. Suitable polyfunctional compounds used in the polymerization of branched polycarbonate include, but are not limited to,

1,1,1-tris(4-hydroxyphenyl)ethane and other tri-hydroxy compounds,

4-[4-[1,1-bis(4-hydroxyphenyl)-ethyl]-dimethylbennzyl], trimellitic anhydride, and trimellitic acid, or their acid chloride derivatives.

In preparing a polycarbonate, an endcapping agent may optionally be used. Suitable endcapping agents include monovalent aromatic hydroxy compounds, haloformate derivatives of monovalent aromatic hydroxy compounds, monovalent carboxylic acids, halide derivatives of monovalent carboxylic acids, other chemicals capable of reacting with a hydroxyl group to produce a non-reactive endgroup and mixtures thereof. Examples of specific suitable endcapping agents include, but are not limited to phenol, p-tert-butylphenol; p-cumylphenol; p-cumylphenolcarbonate; undecanoic acid, lauric acid, stearic acid; phenyl chloroformate, t-butyl phenyl chloroformate, p-cumyl chloroformate, chroman chloroformate, octyl phenyl; nonyl phenyl chloroformate or a mixture thereof.

If present during the interfacial synthesis, the endcapping agent is preferably present in amounts of about 0.01 to about 0.20 moles, preferably about 0.02 to about 0.15 moles, even more preferably about 0.02 to about 0.10 moles per 1 mole of the dihydric phenol.

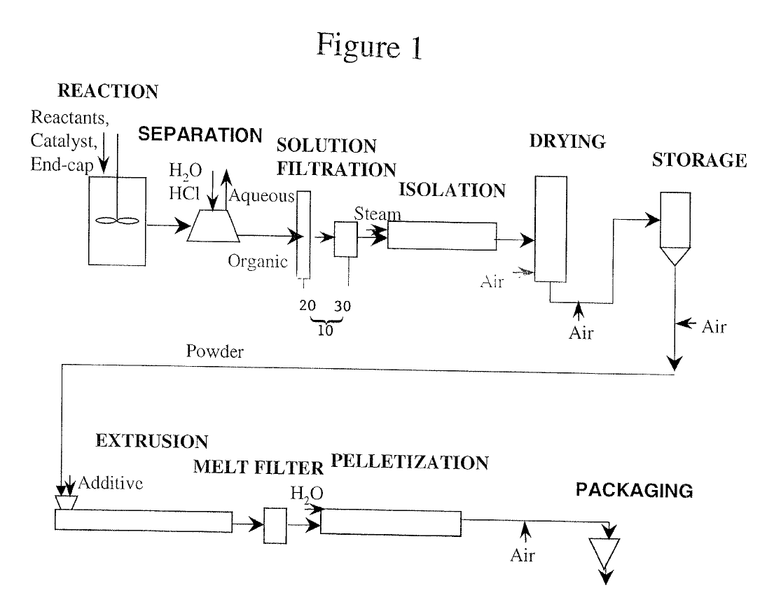

The reaction to produce the polycarbonate can be conducted as a batch or a continuous process. Any desired apparatus can be used for the reaction. The material and the structure of the reactor used in the present invention is not particularly limited as long as the reactor has an ordinary capability of stirring. It is preferable that the reactor is capable of stirring in high viscosity conditions as the viscosity of the reaction system is increased in later stages of the reaction. A diagram of one example of an apparatus for making polycarbonate by interfacial polymerization is shown in FIG. 1. The invention, however, is not limited to this particular example configuration.

The interfacial process for preparing polycarbonate results in a product mixture comprising the product polymer dissolved in the reaction media, which comprises an organic solvent, as mentioned. Typical organic solvents utilized in interfacial polymerizations, as mentioned previously, include, but are not limited to aliphatic hydrocarbons such as pentane, hexane, cyclohexane, and heptane; aromatic hydrocarbons such as toluene, xylene; substituted aromatic hydrocarbons, such as chlorobenzene, dichlorobenzene, and nitrobenezene; chlorinated aliphatic hydrocarbons such as chloroform and methylene chloride, and mixtures of any of the aforementioned solvents. The aforementioned solvents may also be mixed with ethers, including but not limited to tetrahydrofuran. Chlorinated aliphatic hydrocarbons are preferred in interfacial polycarbonate preparation, in particular methylene chloride. Typically, the product mixture comprises from about 5 to about 25% by weight of the product polymer, for instance polycarbonate. In one embodiment of the process, the organic solvent is methylene chloride and the polycarbonates recovered are BPA homopolycarbonates and copolymers prepared therefrom.

It has been found that a two stage filtration system is advantageous for filtering polycarbonate solutions in a separated organic phase prior to isolation of a dried powder in the manufacturing process described above. In a preferred embodiment of this process, a solution of polycarbonate in methylene chloride passes through a two-stage single-pass filtration system 10 such as shown in FIG. 1, which system comprises a first filter 20 and a second filter 30.

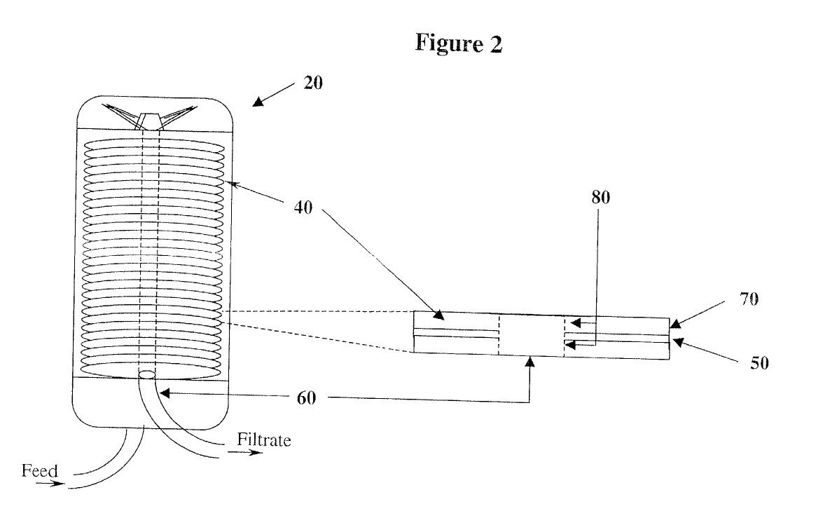

In the first stage, solution passes through a first filter 20. Suitable first filters 20 are those having a nominal pore size of from 1 to 5 micron. It is essential that such filters not be significantly adversely affected by methylene chloride. As depicted in FIG. 2, in one preferred embodiment of the invention, the first filter 20 consists of stacks of disks 40 made from cellulose and inorganic filter aids such as diatomaceous earth. The disks are bonded together by an adhesive 50. The stacks of disks are supported by cylindrical tubes 60, which pass through the cores of the disks 40 and act as discharge channels for the purified filtrate. The disks 40 are typically cast in two layers. The solution enters the disks 40 through their exposed edges 70, and flows in toward the centers of the disks in a radial direction. The permeability of the layers decreases from outside to inside. The filtered solution discharged into the cylindrical tubes 60 via small holes 80. Suitable first filters 20 according to this construction are commercially available from CUNO Inc. under model number Z16PA-30M02. At this first stage of filtration, particulates are reduced and most any remaining water is absorbed. These first filters 20 are preferably capable of reducing particulate levels to below 20,000 per gram of polycarbonate, and more preferably below 15,000 per gram of polycarbonate.

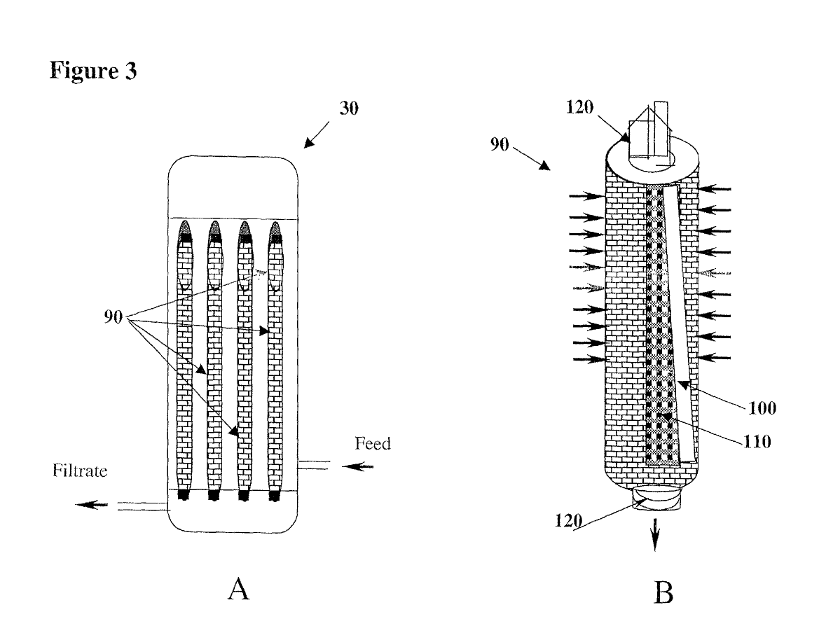

In the second filtration stage located downstream from the first filtration stage the solution passes through a second filter 30. The construction of one type of suitable second filter 30 is depicted in FIGS. 3a and 3b. In FIG. 3a, the second filter 30 has a plurality of candle-type filter cartridges 90. FIG. 3b shows that the candle-type filter have polytetrafluoroethylene membranes 100. These membranes typically have a nominal pore size of 0.8 micron and more preferably 1 micron. The core 110 and endcaps 120 of such filters must be compatible with methylene chloride (i.e., not swell or dissolve). A preferred core material is polypropylene. Such filters are available commercially from CUNO Inc. under model number TF10OBO4FB.

It is most desirable that the core filters according to the present invention have a pressure drop, which does not sharply increase over an acceptable operating period. The operating period should be at least 15 days, and more preferably at least 60 days. It is further desirable that filter system 10 be capable, under normal operating conditions, of reducing the level of particulates having a size above 0.5 micron to below 10,000 per gram of polycarbonate, and more preferably below 8,000 per gram of polycarbonate.

### EXAMPLES

The following examples are set forth to provide those of ordinary skill in the art with a specific description of how to perform the method, but are not intended to limit the scope of what has been invented. Efforts have been made to insure accuracy with respect to all numbers, but some minor errors and deviations should be accounted for.

### Examples 1-16

Table I below depicts the results of comparative tests performed using a cellulose/diatomaceous earth first filter as described above, and numerous types of second candle filters. The removal efficiency was calculated by analyzing samples for particulates upstream and downstream of the filter system using light scattering for small size particles and light extinction for large size particles, specifically, the particulate count measured by a dual mode HIAC ROYCO MicroCount particle counter by Pacific Scientific Inc. The pressure drops were measured by pressure transducers. Small size particles are defined as those of size less (maximum diameter) than 3 micron, and large size particles are defined as those of size greater than 3 micron. Specifically, light scattering measurements were calibrated using 10 polystyrene particle sizes. Light extinction measurements were calibrated using 8 polystyrene particle sizes.

Removal efficiency and pressure drop results are summarized in Table I below.

TABLE I

| | | | Removal | Pressure Drop |
|---|---|---|---|---|
| Filter Element Type | Rating⁽¹⁾ | Comments | Efficiency⁽²⁾ | per Flow Rate⁽³⁾ |
| Candle | | | | |
| Wound Polypropylene | 1 nom | — | 6.70 | 1.00 |
| Depth Polypropylene | 1 nom | — | 3.80 | 0.60 |
| Pleated Polypropylene | 1 abs | — | 25.45 | 0.75 |
| Polypropylene Fiber | 3 nom | — | 51.00 | 0.60 |
| Blown Polypropylene | 2 abs | — | 95.10 | 0.44 |
| Crosslinked Polyethylene | 0.5 nom | — | 67.00 | 0.30 |
| Wound Polyester | 0.5 nom | seals deform | 82.70 | 0.58 |
| Pleated Polyester | 0.5 nom | swell/deform | 95.00 | 0.15 |
| Pleated Microfiberglass | 1 abs | fiber release^{(a)} | 91.00 | 0.10 |
| Polytetrafluoroethylene^{(b)} | 1 abs | — | 87.00 | 0.29 |
| Polytetrafluoroethylene^{(c)} | 1 abs | swell/deform | 94.40 | 0.33 |
| Poly(vinylidene fluoride) | 0.2 nom | — | 48.50 | 0.60 |
| Blown Polypropylene | 5 abs | — | 48.00 | 1.00 |
| Polyacrylamide Fiber | 3 nom | — | 18.50 | 0.15 |
| Polysulfonate | 0.5 nom | — | 97.30 | 1.04 |
| Stainless Steel | 1 nom | — | 5.80 | 0.07 |
| Disk | | | | |
| Cellulose/Diatomaceous | 1 nom | — | 96.50 | 0.21 |
| Earth | | | | |

⁽¹⁾In microns, nominal or absolute
⁽²⁾Percentage
⁽³⁾In (pounds per square inch)/(gallons per minute) for candle elements In (pounds per square inch)/(gallons per minute)/square foot for disk elements
^{(a)}Binding agent acrylic
^{(b)}On Polypropylene
^{(c)}On Polyester

Some of the high efficiency second filters, did not pass the material compatibility test. For example, it was found that methylene chloride impregnated certain filter materials (e.g., polyester), and dissolved others (e.g., binding agents of glass fibers). These materials were excluded from further consideration.

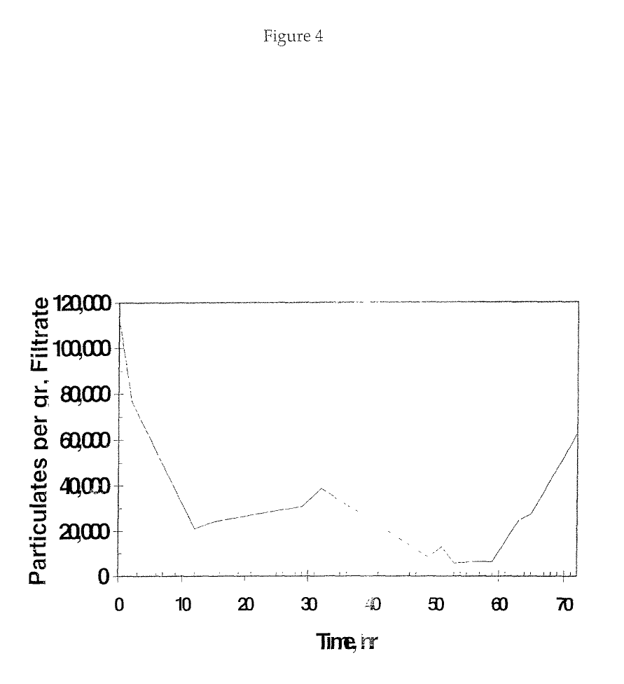

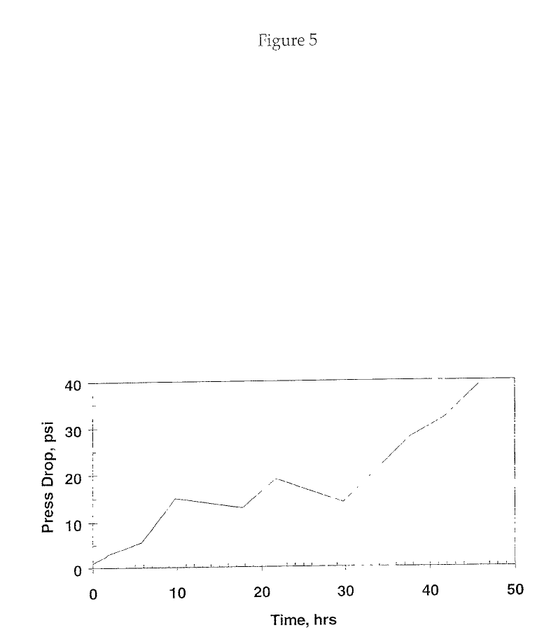

Single-stage tests using a slip stream in a polycarbonate plant were carried out to determine the life time of the second filters with high removal efficiency (greater than 80%) in the pilot plant tests. Second filter lifetime was determined by following the particulate level in the filtrate and the change in pressure drop across the second filter with time without using a first filter. When the particulate level in the feed is controlled to be almost time-invariant, as in a pilot plant, the particulate level in the filtrate decreases sharply upon insertion of the filter levels to a low value for some time and, when the life time of the filter is reached, increases sharply again. In such a case, the filter pressure drop increases gradually initially and sharply as the end of the lifetime of the filter is approached. In the slipstream tests, the particulate level in the feed varies with time, as in the plant. However, even when exposed to such variation, the lifetime of the filter is marked by a steep increase in filtrate particulate level and filter pressure drop as shown in FIGS. 4 and 5.

### Example 17

Examples 1-16 showed that the lifetime of most single-stage candle second filters was less than a couple of days. The causes for the short life were either low particulate holding capacity or structural failure of the filter (filtering material or seal swells and deforms) leading to bypassing. A noticeable result of these tests was that a candle filter with polytetrafluoroethylene membrane on a polypropylene core had a longer lifetime than a similar filter with a membrane of the same material on a polyester core, 3 days vs. 20 hours. It is thought that the difference in lifetime of the two filters may be explained by considering the different swell-in-methylene-chloride rates of the materials of the supporting cores (the polytetrafluoroethylene membranes are not affected by methylene chloride). Upon inspection at the end of the test, the filter with the polyester core was severely deformed while the filter with the polypropylene core retained its integrity.

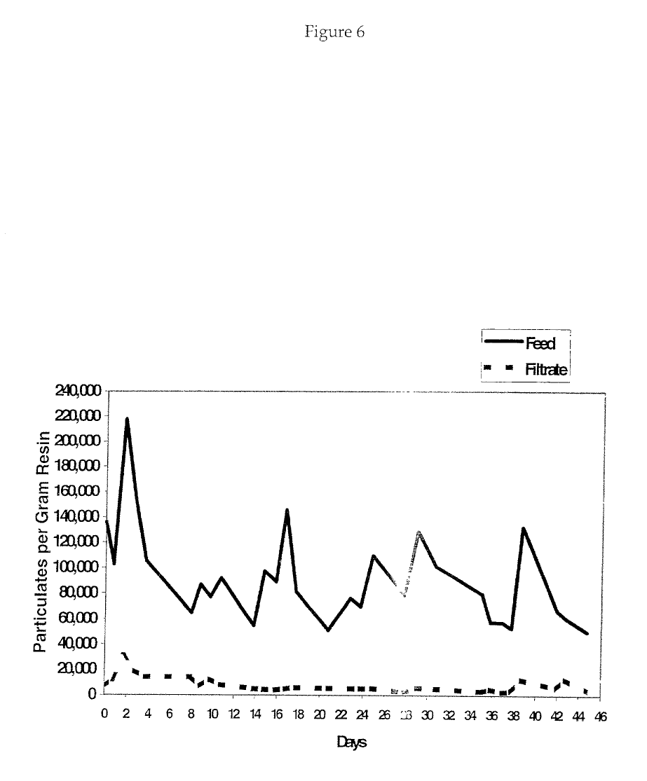

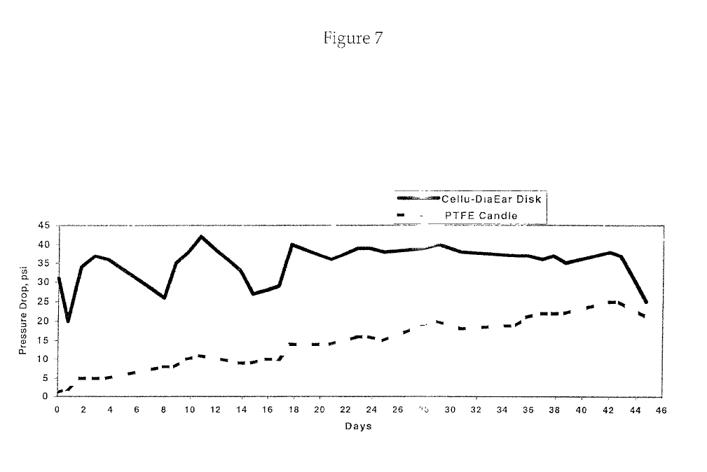

Two-stage filter systems, with a first depth filter in the first stage, were also tested in the slipstream. The lifetime of the candle-type second post-filter (second-stage) increased when used together with a candle-type pre-filter (first-stage), but it was still not acceptable for plant operations. However, it was found that a two-stage system with a disk-type pre-filter and a candle-type post-filter was acceptable. When a disk-type pre-filter (first-stage first filter), was added, the lifetime of the candle-type post-filter (second filter) increased by two orders of magnitude from its value in a single-stage filtration. The results of testing the two-stage filtration system of the present invention are shown in FIGS. 6 and 7.

The flow rate through the first stage disk filters was 0.083 gallons per minute per square foot and the clean pressure drop through these filters was 20-30 pounds per square inch, depending on viscosity of the optical-quality polycarbonate resin passed through the filters. The rate through the second stage candle-type filters was 0.037 gallons per min per square foot and the clean pressure drop ranged from 1 to 3 pounds per square inch, depending on resin viscosity.

FIG. 6 shows that the removal efficiency for most of the 46 day test period was approximately 90%, and the particulates having a size greater than 0.5 micron in the filtrate were reduced to below 10,000 per gram of resin as measured by the light scattering method described above.

FIG. 7 shows that the pressure drop did not reached the stage of sharp increase by the 46 day period.

Particulate and pressure drop measurements showed that in the best cases, the lifetime of the filtration system was greater than 7-8 weeks which is extremely advantageous for practical use.

What is claimed is:

1. A method for purifying polycarbonate, which method comprises passing a solution comprising polycarbonate and methylene chloride through a filtration system having filters, wherein the filtration system reduces the level of particulates having a size greater than 0.5 microns to below 10,000 per gram of the solution, and the filtration system is continuously operated for a period of greater than 15 days without switching or cleaning a filter.

2. The method for making purified polycarbonate according to claim 1, wherein the filtration system comprises a first filter, and a second filter, which second filter comprises polytetrafluoroethylene membrane filter elements, and wherein both the first and second filters are made from materials compatible with methylene chloride, and wherein the first filter is located upstream with respect to the second filter.

3. The method according to claim 1, wherein the second filter comprises candle-type filter cartridges and the polytetrafluoroethylene membrane filer elements are supported on a polypropylene core.

4. The method according to claim 1, wherein the first filter is capable of reducing particulate levels to below 20,000 per gram of polycarbonate.

5. The method according to claim 1, wherein the period is greater than 60 days.

6. The method according to claim 1, wherein the filtration system is capable of reducing the level of particulates having a size greater than 0.5 microns to below 8,000 per gram.

7. The method according to claim 1, wherein the solution consists essentially of polycarbonate and methylene chloride.
